(19) United States
(12) Patent Application Publication
(10) Pub. No.: US 2026/0301683 A1
(43) Pub. Date: Oct. 1, 2026

(54) DISPLAY DEVICE AND METHOD OF DRIVING SAME

(71) Applicant: LG Display Co., Ltd., Seoul (KR)

(72) Inventors: Seon Geun GIM, Paju-si (KR); Geum Seong LEE, Paju-si (KR)

(21) Appl. No.: 19/414,294

(22) Filed: Dec. 10, 2025

(30) Foreign Application Priority Data
Mar. 31, 2025 (KR) 10-2025-0041580

(51) Int. Cl. G09G 3/3266

(52) U.S. Cl. CPC G09G 3/3266; G09G 2300/043; G09G 2300/0814; G09G 2320/0247

(57) ABSTRACT

A display device includes: a display panel configured to display images, a power supply configured to generate a high-level voltage and a low-level voltage for driving the display panel, a gate driver including a scan signal generator configured to apply a scan signal to the display panel and an emission signal generator configured to apply an emission control signal to the display panel, and a timing controller configured to control the gate driver, wherein, the timing controller, based on the high-level voltage output from the power supply, controls a start signal for initiating operation of the gate driver to be output after a time period has elapsed, the time period including a threshold voltage sampling period for sampling threshold voltages of driving transistors included in subpixels of the display panel and a dummy frame addition period of at least one frame.

### CROSS REFERENCE TO RELATED APPLICATION

This application claims priority from and the benefit of Korean Patent Application No. 10-2025-0041580, filed on Mar. 31, 2025, which is hereby incorporated by reference for all purposes as if fully set forth herein.

### BACKGROUND

### FIELD

Embodiments of the invention relate generally to a display device and a method of driving the same, and more particularly, to a display device and a method of driving the same that initiate driving after sufficient sampling is performed under normally generated high-level voltage conditions.

### DISCUSSION OF THE BACKGROUND

With the advancement of information technology, the market for display devices, which serve as a link between users and information, is expanding. Consequently, the use of display devices such as light emitting display devices (LEDs), quantum dot display devices (QDDs), and liquid crystal display devices (LCDs) is increasing.

The display devices described above include a display panel including subpixels, a driver that outputs driving signals to drive the display panel, and a power supply that generates power to be supplied to the display panel and/or the driver.

These display devices display images in such a manner that selected subpixels transmit light or directly emit light when driving signals, such as scan signals and data signals, are supplied to the subpixels formed on the display panel.

The above information disclosed in this Background section is only for understanding of the background of the inventive concepts, and, therefore, it may contain information that does not constitute prior art.

### SUMMARY

Display devices and methods of driving the same according to embodiments of the invention are capable of eliminating flickering or horizontal line defects occurring in a specific area of a display panel by providing a power-on sequence that allows sufficient sampling of the threshold voltage of driving transistors included in subpixels under conditions in which a high-level voltage is normally generated.

In addition, an embodiment of the invention is capable of eliminating screen abnormalities such as flickering or horizontal line defects occurring in a specific area of the display panel, thereby improving display quality, and enhancing driving safety and reliability by initiating driving under conditions in which a high-level voltage is normally generated.

Additional features of the inventive concepts will be set forth in the description which follows, and in part will be apparent from the description, or may be learned by practice of the inventive concepts.

According to one or more embodiments of the invention, a display device includes: a display panel configured to display images, a power supply configured to generate a high-level voltage and a low-level voltage for driving the display panel, a gate driver including a scan signal generator configured to apply a scan signal to the display panel and an emission signal generator configured to apply an emission control signal to the display panel, and a timing controller configured to control the gate driver, wherein, the timing controller, based on the high-level voltage output from the power supply, controls a start signal for initiating operation of the gate driver to be output after a time period has elapsed, the time period including a threshold voltage sampling period for sampling threshold voltages of driving transistors included in subpixels of the display panel and a dummy frame addition period of at least one frame.

The timing controller may further include an internal power circuit configured to generate an internal logic voltage based on an external logic voltage.

The display device may further include a monitor circuit configured to generate a voltage check signal based on the high-level voltage output from the power supply and the internal logic voltage output from the internal power circuit.

The timing controller may further include a gate control circuit configured to output the start signal based on the voltage check signal.

The monitor circuit may output the voltage check signal at a high level in response to both the high-level voltage and the internal logic voltage being at high levels.

The monitor circuit may output the voltage check signal at a low level in response to at least one of the high-level voltage and the internal logic voltage being at a low level.

The monitor circuit may include an AND gate configured to generate the voltage check signal based on a result of an AND operation performed on the high-level voltage and the internal logic voltage.

In response to the voltage check signal being at a high level, the gate control circuit may generate a low-voltage start signal and then generate a high-voltage start signal.

When the dummy frame ends and a new frame starts, the gate control circuit may generate a low-voltage start signal and then generate a high-voltage start signal.

The gate control circuit may control an emission start signal for starting operation of the emission signal generator based on the voltage check signal.

When the voltage check signal is applied as a high voltage, the gate control circuit may generate the emission start signal as a low voltage and then generate the emission start signal as a high voltage based on the voltage check signal applied as a high voltage.

According to one or more embodiments of the invention, a method of driving the display device includes: monitoring the high-level voltage output from the power supply and the internal logic voltage output from the timing controller, outputting the voltage check signal based on the high-level voltage and the internal logic voltage, and controlling the start signal to be output based on the voltage check signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram schematically illustrating a light-emitting display device according to an embodiment of the invention.

FIGS. 2 and 3 are diagrams for describing a configuration of a gate-in-panel type gate driver included in the light-emitting display device of FIG. 1.

FIG. 4 is a diagram illustrating an exemplary circuit configuration of a subpixel included in the light-emitting display device of FIG. 1.

FIG. 5 is a diagram illustrating an exemplary configuration of a gate driver for driving the subpixel of FIG. 4.

FIG. 6 is a block diagram illustrating main components of the light-emitting display device of FIG. 1.

FIG. 7 is a block diagram illustrating a gate control circuit and a monitor circuit illustrated in FIG. 6 in more detail.

FIG. 8 is a waveform diagram for describing the operation of a light-emitting display device according to an embodiment of the invention.

FIG. 9 is a table illustrating the conditional states of the input and output signals of the monitor circuit shown in FIG. 7.

FIG. 10 is a waveform diagram for describing the operation of a light-emitting display device according to a comparative example.

FIG. 11 is a diagram illustrating an operating state of the light-emitting display device of FIG. 8 after power is applied.

FIG. 12 is a diagram illustrating an operating state of the light-emitting display device of FIG. 10 after power is applied.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

A display device according to embodiments of the invention may be implemented in televisions, video players, personal computers (PCs), home theaters, automotive electrical devices, smartphones, and the like, but the embodiment is not limited thereto. The display device according to the embodiment may be implemented as a light-emitting display (LED), a quantum dot display (QDD), or a liquid crystal display (LCD), but the embodiment is not limited thereto. As an example, a light-emitting display that directly emits light based on inorganic or organic light-emitting diodes will be described below for convenience of description.

Furthermore, the transistor described below may be implemented as an n-type transistor, a p-type transistor, or a combination of n-type and p-type transistors. A transistor is a three-electrode device including a gate, a source, and a drain. The source is an electrode that supplies carriers to the transistor. Within the transistor, carriers begin to flow from the source. The drain is an electrode through which carriers exit the transistor. The source and the drain of the transistor can be switched depending on the applied voltage. To reflect this, in the following description, one of the source and drain will be described as a first electrode, and the other of the source and drain will be described as a second electrode.

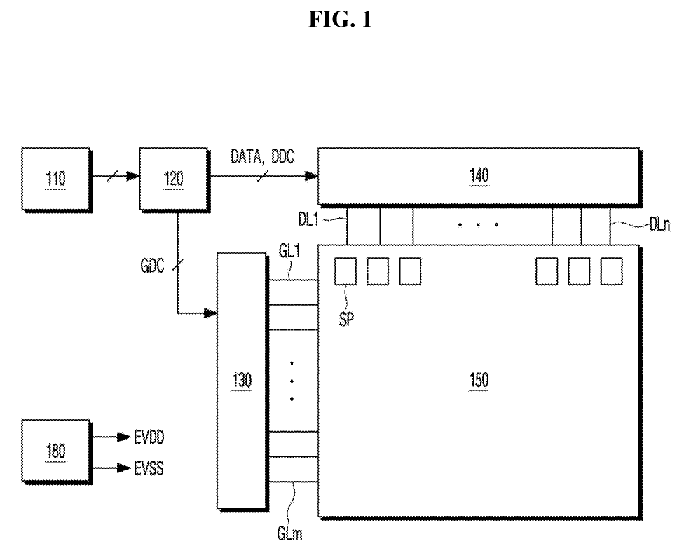

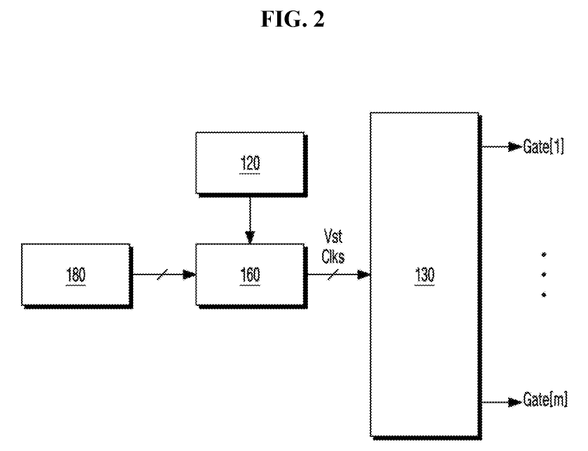

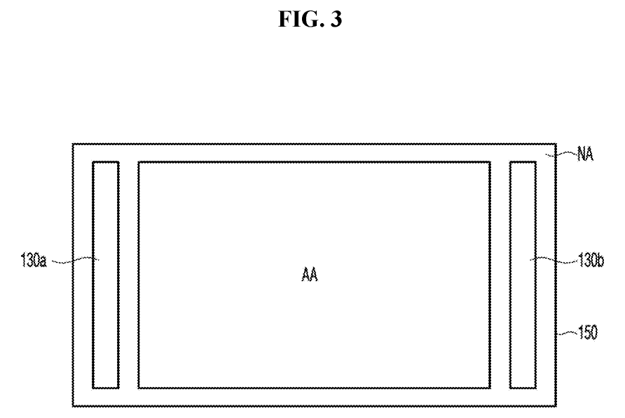

FIG. 1 is a block diagram schematically illustrating a light-emitting display device according to an embodiment of the invention, and FIGS. 2 and 3 are diagrams for describing a configuration of a gate-in-panel type gate driver included in the light-emitting display device of FIG. 1.

As illustrated in FIGS. 1 to 3, the light-emitting display device may include a timing controller (timing control circuit) 120, a gate driver (gate driver circuit) 130, a data driver (data driver circuit) 140, a display panel 150, and a power supply (power supply circuit) 180.

An image provider (set or host system) 110 may output various driving signals in addition to an image data signal supplied from an external source or an image data signal stored in an internal memory. The image provider 110 may supply a data signal and various driving signals to the timing controller 120.

The timing controller 120 may output a gate timing control signal GDC for controlling an operation timing of the gate driver 130, a data timing control signal DDC for controlling an operation timing of the data driver 140, and various synchronization signals (vertical synchronization signal (Vsync) and horizontal synchronization signal (Hsync)). The timing controller 120 may supply a data signal DATA supplied from the image provider 110 along with the data timing control signal DDC to the data driver 140. The timing controller 120 may be formed in the form of an integrated circuit (IC) and mounted on a printed circuit board, but the embodiment is not limited thereto.

The gate driver 130 may output a gate signal in response to the gate timing control signal GDC supplied from the timing controller 120. The gate driver 130 may supply gate signals to subpixels included in the display panel 150 through gate lines GL1 to GLm. The gate driver 130 may be formed in an IC form or directly formed on the display panel 150 in a gate-in panel structure, but the embodiment is not limited thereto. For example, a gate driver in the gate-in panel (GIP) structure will be described below for convenience of description, as illustrated in FIGS. 2 and 3.

The gate driver 130 may include shift registers 130a and 130b. The shift registers 130a and 130b may be formed to have a thin film form in a non-active area NA of the display panel 150 in the gate-in-panel structure. The gate driver 130 may output gate signals Gate[1] to Gate[m] for turning on or off transistors formed in an active area AA of the display panel 150.

The gate driver 130 may operate based on signals and voltages output from the timing controller 120, the power supply 180, and a level shifter 160. The level shifter 160 may generate gate control signals necessary for operation of the gate driver 130 and the shift registers 130a and 130b therein based on signals and voltages output from the timing controller 120 and the power supply 180.

The data driver 140 samples and latches a data signal DATA in response to the data timing control signal DDC supplied from the timing controller 120, converts the digital data signal into an analog data voltage based on a gamma reference voltage, and outputs the analog data voltage.

The data driver 140 may supply a data voltage to subpixels included in the display panel 150 via data lines DL1 to DLn. The data driver 140 may be formed in an IC form and mounted on the display panel 150 or on a printed circuit board, but the embodiment is not limited thereto.

The power supply 180 may generate a high-level voltage and a low-level voltage based on an external input voltage, and output the same through a high-level voltage line EVDD and a low-level voltage line EVSS. The power supply 180 may generate and output not only the high-level voltage and the low-level voltage, but also a voltage required to drive the gate driver 130 or a voltage required to drive the data driver 140.

The display panel 150 may be manufactured based on a rigid or flexible substrate such as glass, silicon, or polyimide. The display panel 150 may include a plurality of subpixels SP for displaying images. The subpixels SP may directly emit light toward the upper substrate, the lower substrate, or the upper and lower substrates of the display panel 150. The subpixels SP may emit one of red, green, blue, and white light. The display panel 150 may display images based on pixels composed of red subpixels, green subpixels, and blue subpixels, or pixels composed of red subpixels, green subpixels, blue subpixels, and white subpixels.

Although the timing controller 120, the gate driver 130, and the data driver 140 have been described as individual components, in some embodiments, one or more of the timing controller 120, the gate driver 130, and the data driver 140 may be integrated into a single IC depending on the implementation method of the light-emitting display device.

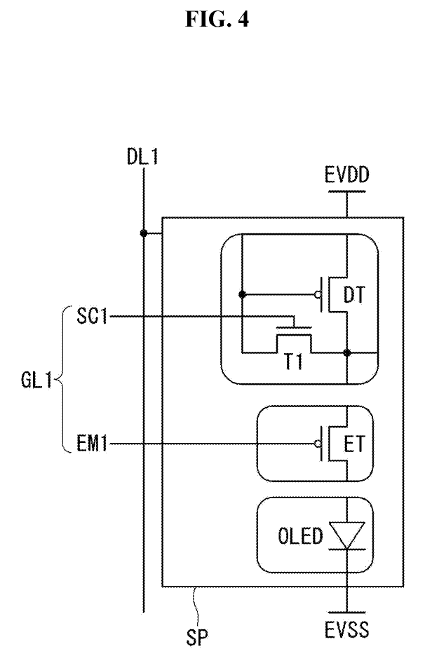

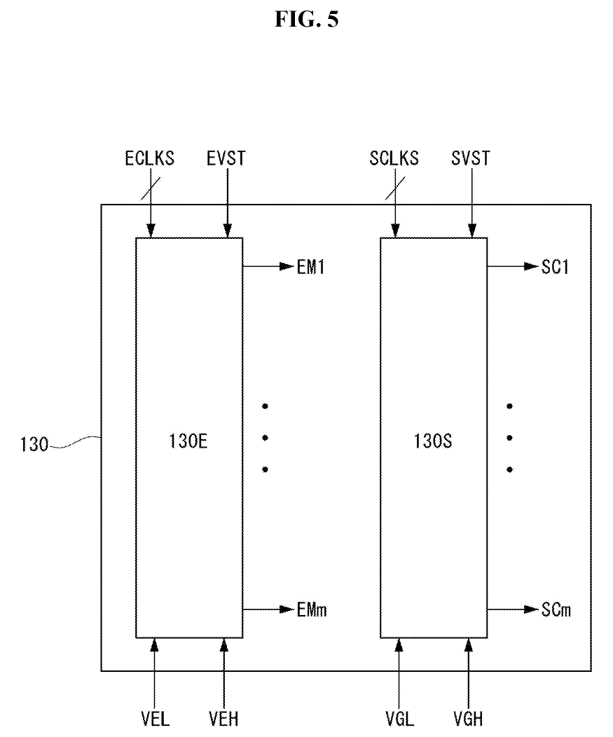

FIG. 4 is a diagram illustrating an exemplary circuit configuration of a subpixel included in the light-emitting display device of FIGS. 1 and 5 is a diagram illustrating an exemplary configuration of a gate driver for driving the subpixel of FIG. 4.

As illustrated in FIG. 4, the subpixel SP may be connected to a first data line DL1 for transmitting a data voltage, a first gate line GL1 for transmitting a gate signal, a high-level voltage line EVDD for transmitting a high-level voltage, and a low-level voltage line EVSS for transmitting a low-level voltage. The first gate line GL1 may include a first scan line SC1 for transmitting a first scan signal, and a first emission control line EM1 for transmitting a first emission control signal.

The subpixel SP may include a driving transistor DT, a switching transistor T1, an emission control transistor ET, and a light-emitting diode OLED. The driving transistor DT and the emission control transistor ET may be p-type transistors, and the switching transistor T1 may be an n-type transistor. However, the inventive concepts are not limited thereto.

The driving transistor DT may generate a driving current to be applied to the light-emitting diode OLED. The switching transistor T1 may diode-connect the gate electrode and the second electrode of the driving transistor DT to sample the threshold voltage of the driving transistor DT. The emission control transistor ET may apply the driving current generated from the driving transistor DT to the anode of the light-emitting diode OLED. The light-emitting diode OLED may emit light based on the driving current generated from the driving transistor DT.

The switching transistor T1 can be turned on based on the first scan signal transmitted through the first scan line SC1. The emission control transistor ET can be turned on based on the first emission control signal transmitted through the first emission control line EM1.

The connection relationship between the driving transistor DT, the switching transistor T1, the emission control transistor ET, and the light-emitting diode OLED may vary depending on a circuit that may be additionally included within the subpixel SP and driving method. FIG. 4 illustrates only selected circuits included within the subpixel SP, and thus omits the connection relationship between the electrical components and a capacitor in which a data voltage is stored.

A display panel implemented based on the subpixel SP illustrated in FIG. 4 may operate based on the gate driver 130 illustrated in FIG. 5. The gate driver 130 may include an emission signal generator 130E connected to the first emission control line EM1 to the M-th emission control line EMm and implemented in the form of a shift register, and a scan signal generator 130S connected to the first scan signal line SC1 to the M-th scan signal line SCm and implemented in the form of a shift register. The emission signal generator 130E and the scan signal generator 130S may be implemented in a gate-in-panel structure.

The emission signal generator 130E may operate based on emission clock signals transmitted through emission clock signal lines ECLKS and an emission start signal transmitted through an emission start signal line EVST, and output the first emission control signal to the M-th emission control signal. The emission clock signal lines ECLKS may include at least two emission clock signal lines having different phases. The emission signal generator 130E may start operation when a high voltage emission start signal is applied. The emission signal generator 130E may generate the first emission control signal to the M-th emission control signal based on a first gate high voltage applied through a first gate high voltage line VEH and a first gate low voltage applied through a first gate low voltage line VEL.

The scan signal generator 130S may operate based on scan clock signals transmitted through scan clock signal lines SCLKS and a scan start signal transmitted through a scan start signal line SVST, and output the first scan signal to the M-th scan signal. The scan clock signal lines SCLKS may include at least four scan clock signal lines having different phases. The scan signal generator 130S may start operation when a high voltage scan start signal is applied. The scan signal generator 130S may generate the first scan signal to the M-th scan signal based on a second gate high voltage applied through a second gate high voltage line VGH and a second gate low voltage applied through a second gate low voltage line VGL.

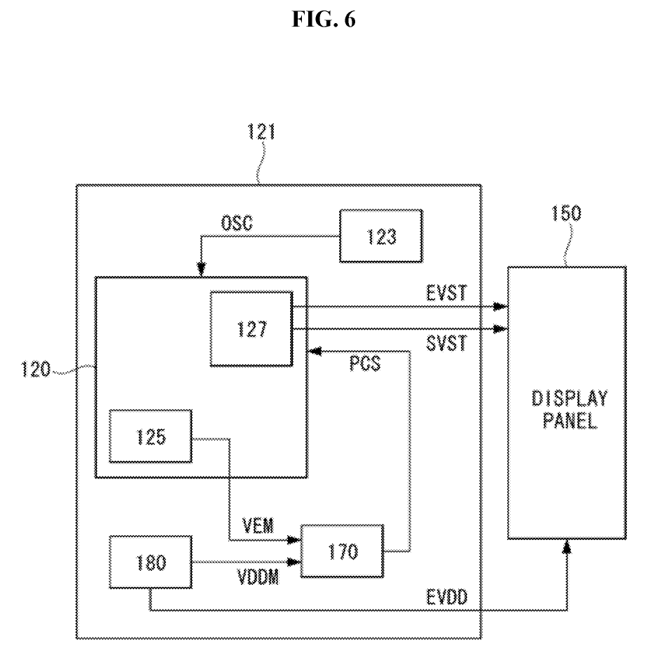

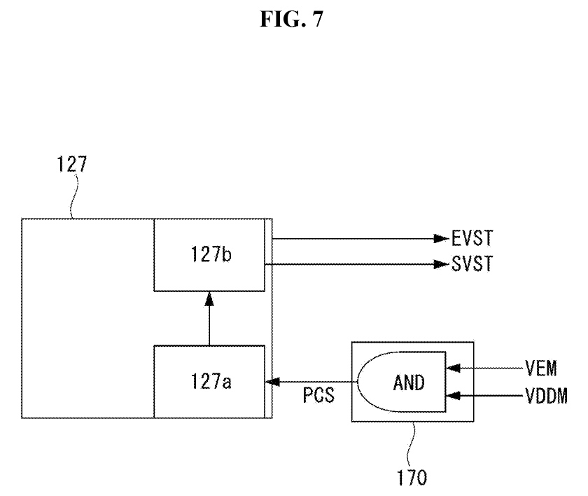

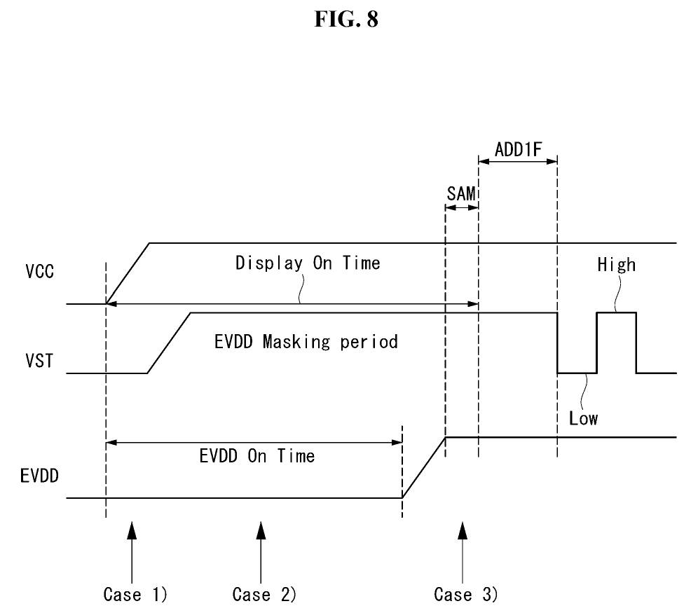

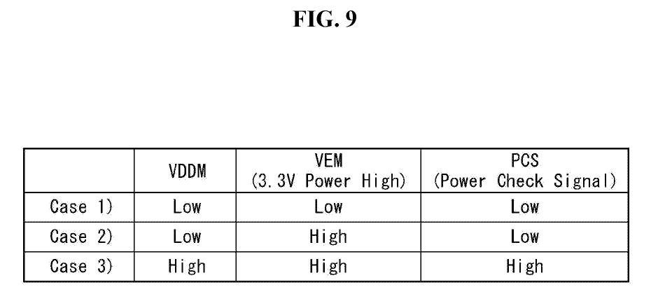

FIG. 6 is a block diagram illustrating main components of the light-emitting display device of FIG. 1, FIG. 7 is a block diagram illustrating a gate control circuit and a monitor circuit illustrated in FIG. 6 in more detail, FIG. 8 is a waveform diagram for describing the operation of the light-emitting display device according to an embodiment of the invention, and FIG. 9 is a table illustrating the conditional states of the input and output signals of the monitor circuit shown in FIG. 7. In particular, FIG. 9 is a diagram showing output states of a voltage check signal according to different conditions shown in FIG. 8.

As illustrated in FIGS. 5 and 6, the light-emitting display device according to an embodiment may include a display panel 150 for displaying images and a control circuit board 121 that generates signals and voltages for driving and controlling the display panel 150.

The display panel 150 may include a gate driver 130 formed in a gate-in-panel structure. The control circuit board 121 may include a timing controller 120, an oscillator 123, a power supply 180, a monitor circuit 170, and the like.

The timing controller 120 operates based on an oscillation signal OSC output from the oscillator 123 and may generate and output various signals. The timing controller 120 may include an internal power circuit 125 that generates and outputs an internal logic voltage required to drive the circuit included therein, and a gate control circuit 127 that generates and outputs start signals required to drive the gate driver 130. The gate control circuit 127 may generate the emission start signal to be applied through the emission start signal line EVST and the scan start signal to be applied through the scan start signal line SVST.

Referring to FIG. 7, the monitor circuit 170 may monitor a high-level voltage output from the power supply 180 and an internal logic voltage output from the internal power circuit 125, and generate and output a voltage check signal PCS based on the monitored voltages. More particularly, the monitor circuit 170 may sense the high-level voltage via a monitor voltage line VDDM connected to the power supply 180 and the internal logic voltage via a logic voltage line VEM connected to the internal power circuit 125. For example, referring to FIG. 9, the states of the high-level voltage output from the power supply 180 and the internal logic voltage output from the internal power circuit 125, both of which are voltages applied as input signals to the monitor circuit 170, may be confirmed via the monitor voltage line VDDM and the voltage line VEM, respectively, as well as the state of the power check signal PCS output as an AND operation result of these input signals.

As illustrated in FIG. 7, the monitor circuit 170 senses the monitor voltage line VDDM and the logic voltage line VEM, and may generate the voltage check signal PCS based on the result of an AND operation (logical product) performed on the voltages acquired through sensing. Accordingly, the monitor circuit 170 may further include a circuit that converts an analog voltage into a digital signal and outputs the same. However, it should be noted that in FIG. 7, the monitor circuit 170 is exemplarily illustrated as including only an AND gate AND so as to maintain clarity in the illustration of the inventive concepts.

The gate control circuit 127 may include a first gate control circuit 127a that outputs a driving control signal depending on the state of the voltage check signal PCS and a second gate control circuit 127b that controls a start signal based on the driving control signal. The gate control circuit 127 may control at least one of the emission start signal output through the emission start signal line EVST or the scan start signal output through the scan start signal line SVST based on the voltage check signal PCS.

In the following, an example in which the emission start signal output through the emission start signal line EVST is controlled based on the voltage check signal PCS will be described.

As illustrated in FIGS. 6 and 9, the monitor circuit 170 may output the voltage check signal PCS based on a high-level voltage sensed through the monitor voltage line VDDM (or high-level voltage line EVDD) (refer to the voltage state of the VDDM illustrated in FIG. 9) and an internal logic voltage sensed through the logic voltage line VEM (refer to the voltage state of the VEM illustrated in FIG. 9).

Referring to FIG. 9, the monitor circuit 170 may output a voltage check signal PCS at a low voltage in a first condition (Case 1) and a second condition (Case 2), and output a voltage check signal PCS at a high voltage in a third condition (Case 3).

As shown in FIG. 9, the period corresponding to the first condition (Case 1) may be defined as a period in which the high-level voltage and the internal logic voltage are output as a low voltage. In other words, referring to FIG. 8, the period corresponding to the first condition (Case 1) may include a period in which only an external logic voltage VCC required for operation of the timing controller 120 or the like is output as a high voltage.

The period corresponding to the second condition (Case 2) may be defined as a period in which the high-level voltage is output as a low voltage, and the external logic voltage VCC and the internal logic voltage are output as a high voltage. In other words, referring to FIG. 8, the period corresponding to the second condition (Case 2) may be defined as a period in which the high-level voltage is not output and is masked (EVDD masking period). For example, in FIG. 8, the EVDD masking period may correspond to the duration of the second condition (Case 2), during which EVDD remains masked. Meanwhile, the internal power circuit 125 included in the timing controller 120 may generate the internal logic voltage (e.g., 3.3 V) based on the external logic voltage VCC and output the same as a high voltage from the period corresponding to the second condition (Case2), but the embodiment is not limited thereto.

The period corresponding to the third condition (Case3) may be defined as a period in which the external logic voltage VCC, the high-level voltage, and the internal logic voltage are all output as a high voltage. Additionally, a period corresponding to the first condition (Case1) and the second condition (Case2) may be defined as a high-level voltage on time (EVDD On Time), during which the high-level voltage starts to be generated, and a period corresponding to the first condition (Case1) to the third condition (Case3) may be defined as a display on time (Display On Time), during which the light-emitting display device starts to operate.

For example, referring to FIGS. 7, 8 and 9, when a high voltage check signal PCS is output from the monitor circuit 170 during the period corresponding to the third condition (Case3), the gate control circuit 127 may output a low voltage, and then generate a emission start signal VST having a high voltage level and output the same through the emission start signal line EVST. In other words, the gate control circuit 127 may generate the high-voltage emission start signal VST only under the condition that the high-level voltage and the internal logic voltage are output as high voltages.

The emission start signal VST may be generated as a high voltage after the external logic voltage VCC is generated as a high voltage. As shown in FIG. 8, the transition of the emission start signal VST to a low voltage occurs after a time period that includes a threshold voltage sampling period SAM for sampling the threshold voltage of the driving transistors included in the subpixels of the display panel, following generation of the high-level voltage of the high voltage and elapse of a dummy frame addition period ADD1F in which at least one more frame is added. Thereafter, the emission start signal VST may be generated as a high voltage. For example, the emission start signal VST, which transitions to a low level after the SAM and ADD1F periods, may operate as a start signal for initiating the driving of the gate driver. Alternatively, the emission start signal VST may be generated as the high voltage from a low voltage when the dummy frame ends and a new frame begins.

Hereinafter, the advantages of generating a high-voltage emission start signal VST during the time period including the threshold voltage sampling period SAM and the dummy frame addition period ADD1F and then generating a low-voltage emission start signal VST will be described.

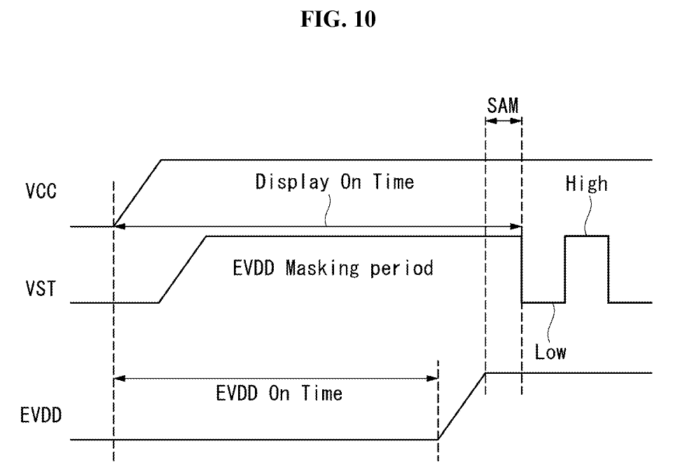

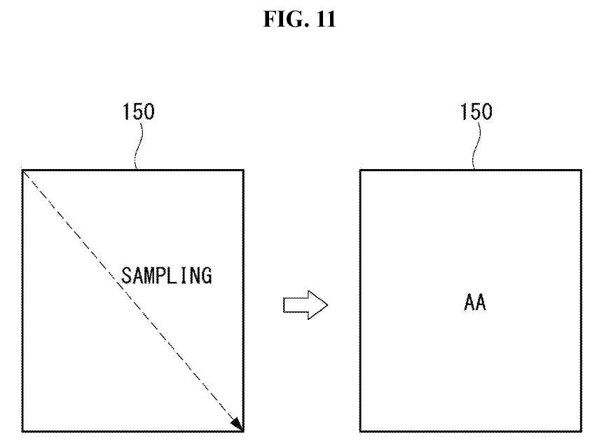

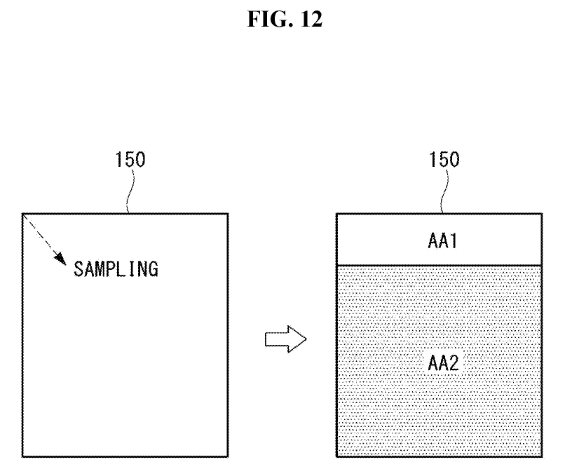

FIG. 10 is a waveform diagram for describing the operation of a light-emitting display device according to a comparative example, FIG. 11 is a diagram showing an operating state of the light-emitting display device of FIG. 8 after power is applied, and FIG. 12 is a diagram showing an operating state of the light-emitting display device of FIG. 10 after power is applied.

As illustrated in FIG. 8, the light-emitting display device according to an embodiment can generate the high-voltage emission start signal VST during the time period including the threshold voltage sampling period SAM and the dummy frame addition period ADD1F, and then generate the low-voltage emission start signal VST.

The light-emitting display device according to an embodiment generates the low-voltage emission start signal VST after providing the time period including the threshold voltage sampling period SAM and the dummy frame addition period ADD1F, and thus a sufficient time SAMPLING for sampling the threshold voltage of the driving transistors included in the subpixels of the display panel 150 can be secured, as illustrated in FIG. 11. That is, the light-emitting display device according to an embodiment can sample the threshold voltage of the driving transistors included in the subpixels for a sufficient period of time in a state in which the high-level voltage is in a normal voltage condition.

The light-emitting display device according to the comparative example can generate a high-voltage emission start signal VST during a time period including the threshold voltage sampling period SAM, and then generate a low-voltage emission start signal VST, as illustrated in FIG. 10.

Since the light-emitting display device according to the comparative example provides the time period including only the threshold voltage sampling period SAM and then generates the low-voltage emission start signal VST, a sufficient time SAMPLING for sampling the threshold voltage of the driving transistors included in the subpixels of the display panel 150 cannot be secured, as illustrated in FIG. 12.

Accordingly, the light-emitting display device according to an embodiment can secure a sufficient margin for the threshold voltage sampling period SAM in the power-on sequence when the light-emitting display device operates in a low-temperature environment (e.g., -40°C), thereby eliminating (or minimizing) flickering or horizontal line defects occurring in a specific area of the display panel 150.

On the other hand, the light-emitting display device according to the comparative example cannot secure a sufficient margin for the threshold voltage sampling period SAM in the power-on sequence when operating in a low-temperature environment (e.g., -40°C), which may cause flickering or horizontal line defects in a specific area of the display panel 150.

Meanwhile, in a low-temperature reliability environment, a voltage rising time may be further delayed due to low electron mobility for a high-level voltage, which may result in insufficient margin for the threshold voltage sampling period SAM. FIG. 12 illustrates, as an example, the occurrence of flickering or horizontal line defects in “AA1”. However, it should be noted that such phenomena may vary depending on the characteristics of the devices constituting the light-emitting display device.

Embodiments of the invention can provide a power-on sequence through which sampling of the threshold voltage of driving transistors included in the subpixels can be performed for a sufficient amount of time under conditions in which a high-level voltage is normally generated, thereby eliminating occurrence of flickering or horizontal line defects in a specific area of the display panel. In addition, embodiments of the invention is capable of substantially eliminating screen abnormality in which flickering or horizontal line defects occur in a specific area of the display panel, thereby improving display quality, and increase driving safety and reliability by starting driving under conditions in which a high-level voltage is normally generated.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a display panel configured to display images;
a power supply configured to generate a high-level voltage and a low-level voltage for driving the display panel;
a gate driver including a scan signal generator configured to apply a scan signal to the display panel and an emission signal generator configured to apply an emission control signal to the display panel; and
a timing controller configured to control the gate driver,
wherein, the timing controller, based on the high-level voltage output from the power supply, controls a start signal for initiating operation of the gate driver to be output after a time period has elapsed, the time period including a threshold voltage sampling period for sampling threshold voltages of driving transistors included in subpixels of the display panel and a dummy frame addition period of at least one frame.

2. The display device of claim 1, wherein the timing controller further comprises an internal power circuit configured to generate an internal logic voltage based on an external logic voltage.

3. The display device of claim 2, further comprising a monitor circuit configured to generate a voltage check signal based on the high-level voltage output from the power supply and the internal logic voltage output from the internal power circuit.

4. The display device of claim 3, wherein the timing controller further comprises a gate control circuit configured to output the start signal based on the voltage check signal.

5. The display device of claim 3, wherein the monitor circuit outputs the voltage check signal at a high level in response to both the high-level voltage and the internal logic voltage being at high levels.

6. The display device of claim 3, wherein the monitor circuit outputs the voltage check signal at a low level in response to at least one of the high-level voltage and the internal logic voltage being at a low level.

7. The display device of claim 3, wherein the monitor circuit includes an AND gate configured to generate the voltage check signal based on a result of an AND operation performed on the high-level voltage and the internal logic voltage.

8. The display device of claim 4, wherein, in response to the voltage check signal being at a high level, the gate control circuit generates a low-voltage start signal and then generates a high-voltage start signal.

9. The display device of claim 4, wherein, when the dummy frame ends and a new frame starts, the gate control circuit generates a low-voltage start signal and then generates a high-voltage start signal.

10. The display device of claim 4, wherein the gate control circuit controls an emission start signal for starting operation of the emission signal generator based on the voltage check signal.

11. The display device of claim 10, wherein when the voltage check signal is applied as a high voltage, the gate control circuit generates the emission start signal as a low voltage and then generates the emission start signal as a high voltage.

12. A method of driving the display device of claim 3, the method comprising:
monitoring the high-level voltage output from the power supply and the internal logic voltage output from the timing controller;
outputting the voltage check signal based on the high-level voltage and the internal logic voltage; and
controlling the start signal to be output based on the voltage check signal.

13. The method of claim 12, further comprising outputting the voltage check signal at a high level in response to both the high-level voltage and the internal logic voltage being at high levels.

14. The method of claim 12, further comprising outputting the voltage check signal at a low level in response to at least one of the high-level voltage and the internal logic voltage being at a low level.

15. The method of claim 12, further comprising generating a low-level start signal and subsequently generating a high-level start signal in response to the voltage check signal being at a high level.

16. The method of claim 12, further comprising generating a low-level start signal and subsequently generating a high-level start signal when the dummy frame ends and a new frame starts.
